(19) United States
(12) Patent Application Publication
(10) Pub. No.: US 2025/0266052 A1
(43) Pub. Date: Aug. 21, 2025

(54) SELF-SUPERVISED SPEECH QUALITY ESTIMATION AND ENHANCEMENT

(71) Applicant: NVIDIA Corp., Santa Clara, CA (US)

(72) Inventors: Szu-Wei Fu, Ren’ai Dist (TW); Yu-Chiang Wang, Neihu District (TW)

(73) Assignee: NVIDIA Corp., Santa Clara, CA (US)

(21) Appl. No.: 18/904,841

(22) Filed: Oct. 2, 2024

Related U.S. Application Data
(60) Provisional application No. 63/555,537, filed on Feb. 20, 2024.

(51) Int. Cl. G10L 25/60; G10L 19/00; G10L 19/038; G10L 25/30

(52) U.S. Cl. CPC G10L 25/60; G10L 19/038; G10L 25/30; G10L 2019/0004

(57) ABSTRACT

Self-supervised mechanisms to evaluate speech quality, and self-supervised speech enhancement, based on the quantization error of a vector-quantized variational autoencoder that utilize clean speech with domain knowledge of speech processing incorporated into the model design to improve correlation with real quality scores; and a self-distillation mechanism combined with adversarial training.

### CROSS-REFERENCE TO RELATED APPLICATIONS

This application claims priority and benefit under 35 USC 119(e) to U.S. Application No. 63/555,537, “SELF-SUPERVISED SPEECH QUALITY ESTIMATION AND ENHANCEMENT USING ONLY CLEAN SPEECH”, filed on Feb. 20, 2024, the contents of which are incorporated herein by reference in their entirety.

### BACKGROUND

Speech quality estimators are important tools in speech-related applications such as text-to-speech, speech enhancement (SE), and speech codecs.

A straightforward approach to measure speech quality is through subjective listening tests. During the test, participants are asked to listen to audio samples and provide their judgment (for example, on a 1 to 5 Likert scale). A mean opinion score (MOS) of an utterance may be obtained by averaging the scores given by different listeners. Although subjective listening tests are generally treated as the “gold standard,” such tests are time consuming and expensive, which restricts their scalability.

Objective metrics have been proposed and applied as surrogates for subjective listening tests. Objective metrics may be categorized into handcrafted and machine learning-based methods. The handcrafted metrics are typically designed by speech experts. Examples of this approach include the perceptual evaluation of speech quality (PESQ) (Rix et al., 2001), perceptual objective listening quality analysis (POLQA) (Beerends et al., 2013), virtual speech quality objective listener (ViSQOL) (Chinen et al., 2020), short-time objective intelligibility (STOI) (Taal et al., 2011), hearing-aid speech quality index (HASQI) (Kates & Arehart, 2014a), and hearing-aid speech perception index (HASPI) (Kates & Arehart, 2014b), etc.

The computation of these methods is mainly based on comparing degraded speech with its clean reference and hence belongs to the category of intrusive metrics. The requirement for clean speech references significantly hinders their application in real-world conditions.

Machine-learning-based methods have been proposed to eliminate the dependence on clean speech references during inference and can be further divided into two categories. The first attempts to non-intrusively estimate the objective scores mentioned above. However, during training, noisy/processed and clean speech pairs are still required to obtain the objective scores as model targets. These models relax the requirement of corresponding clean reference during inference. However their training targets (objective metrics) are generally not perfectly correlated with human judgments

Another type of machine-learning-based method utilizes speech and its subjective scores (e.g., MOS) for model training. To train a robust quality estimator, large-scale listening tests are required by this type of model to collect paired speech and MOS data for supervision.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a speech quality evaluator and/or speech enhancement system in one embodiment.

FIG. 2 depicts a conventional supervised speech quality estimation model in one embodiment.

FIG. 3 depicts a conventional speech quality enhancement model in one embodiment.

FIG. 4 depicts an embodiment of a deep learning model for speech quality estimation and/or speech quality enhancement.

FIG. 5 depicts a parallel processing unit 502 in accordance with one embodiment.

FIG. 6 depicts a general processing cluster 600 in accordance with one embodiment.

FIG. 7 depicts a memory partition unit 700 in accordance with one embodiment.

FIG. 8 depicts a streaming multiprocessor 800 in accordance with one embodiment.

FIG. 9 depicts a processing system 900 in accordance with one embodiment.

FIG. 10 depicts an exemplary processing system in accordance with another embodiment.

FIG. 11 depicts an exemplary processing system 1100 in accordance with another embodiment.

### DETAILED DESCRIPTION

Autoencoders are a type of artificial neural network that may be utilized for unsupervised learning. Autoencoders learn efficient encodings of input data. An autoencoder comprises an encoding stage and a decoding stage. The encoding stage transforms inputs into a lower-dimensional representation referred to herein as a latent space. The decoding stage reconstructs the inputs from the lower-dimensional representation, with an objective to minimize the difference between the input and the reconstructed output, typically using a loss function such as mean squared error. Autoencoders are applicable to a variety of applications, including dimensionality reduction, noise reduction, anomaly detection, and feature learning.

Self-distillation is a technique used to improve the performance of deep learning models by applying settings distilled from the model itself. First, teacher model is trained with original inputs comprising “hard” labels. The teacher model is then used to generate soft targets (probabilistic outputs) for the original training inputs. These soft targets provide more nuanced information than do hard labels. A student model is created having the same model architecture as the teacher model. The student model is re-trained using a combination of the original hard labels and the soft targets produced by the teacher model. The re-training may be carried out by minimizing a loss function that includes a weighted sum of the cross-entropy loss with the hard labels, and a distillation loss (e.g., Kullback-Leibler divergence) with the soft targets.

During self-distillation, the student model benefits from the regularizing effects of using soft targets, which facilitates the learning more generalizable features. Hyperparameters such as the temperature of a Softmax function and loss weightings may be fine-tuned to further optimize the student model's performance.

Self-distillation may be beneficial in reducing overfitting and often leads to improved model generalization by enriching the training process with additional informative signals provided by the soft targets.

Adversarial training is a process that may enhance the robustness of deep learning models by exposing them to adversarial examples during the training process. Adversarial examples are inputs to the model during training that are deliberately perturbed in a way that causes the model to make incorrect predictions.

Adversarial inputs may be generated by applying small perturbations to the original training data in a manner that deceives the model. Popular methods for generating adversarial inputs include the Fast Gradient Sign Method (FGSM) and Projected Gradient Descent (PGD).

Disclosed herein are embodiments of self-supervised autoencoders that evaluate speech quality. The disclosed autoencoders may also be utilized for self-supervised speech enhancement. In one embodiment the models are vector-quantized variational autoencoders (VQVAE) that utilize clean speech with domain knowledge of speech processing incorporated into the model design to improve correlation with real quality scores. The models may also utilize a self-distillation mechanism combined with adversarial training.

During training, the input speech signals to the model may comprise a pattern different from that of the corresponding clean speech, resulting in a higher the reconstruction error. Rather than the conventional process of directly computing the reconstruction error in the signal domain, the disclosed mechanisms may obtain a higher correlation with objective and subjective speech quality scores by calculating the error distance (e.g., the quantization error) in the latent space of the VQVAE. In this process no quality labels may be required or utilized during model training, and yet the correlation coefficient between the model's predicted quality scores and standard quality scores may be competitive with that obtained by supervised models.

The disclosed self-distillation mechanisms combined with adversarial training may be utilized to configure speech enhancement models competitive with supervised models, without the need to apply <noisy, clean> speech training pairs.

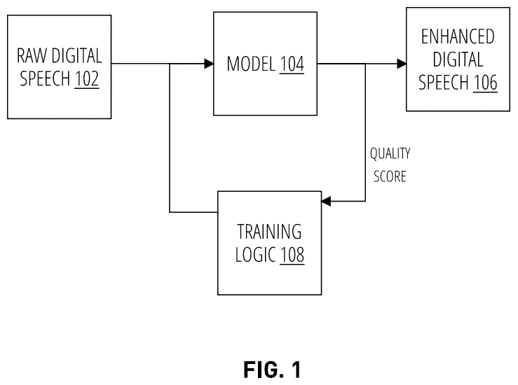

FIG. 1 depicts a speech quality evaluator and/or speech enhancement system in one embodiment. The system comprises a speech evaluation/enhancement model 104 that transforms raw digital speech 102 into cleaner (with noise/anomalies removed) enhanced digital speech 106. Training logic 108 is provided to configure the model 104 for these purposes.

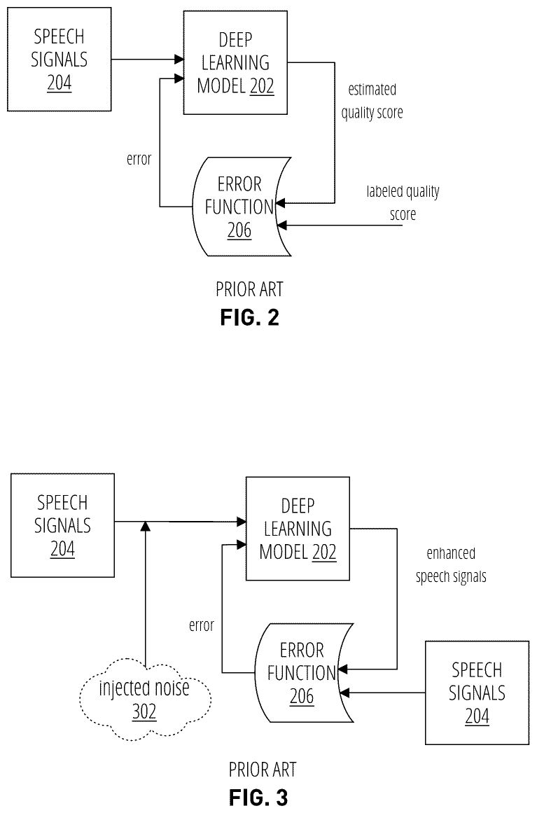

FIG. 2 depicts a conventional supervised speech quality estimation model in one embodiment. A deep learning model 202 is provided during training with a labeled speech signals 204, and the model parameters (e.g., weights) are updated according to the output of an error function 206 that compares the estimated quality scores output from the deep learning model 202 and the labeled quality scores associated with the inputs.

FIG. 3 depicts a conventional speech quality enhancement model in one embodiment. The deep learning model 202 transforms the input speech signals 204 injected noise 302 into enhanced (i.e., cleaner) speech signals. During training of the deep learning model 202, injected noise 302 is added to the input speech signals 204 and the model parameters are updated according to the output of the error function 206, which compares the enhanced speech output of the deep learning model 202 with the input speech signals 204.

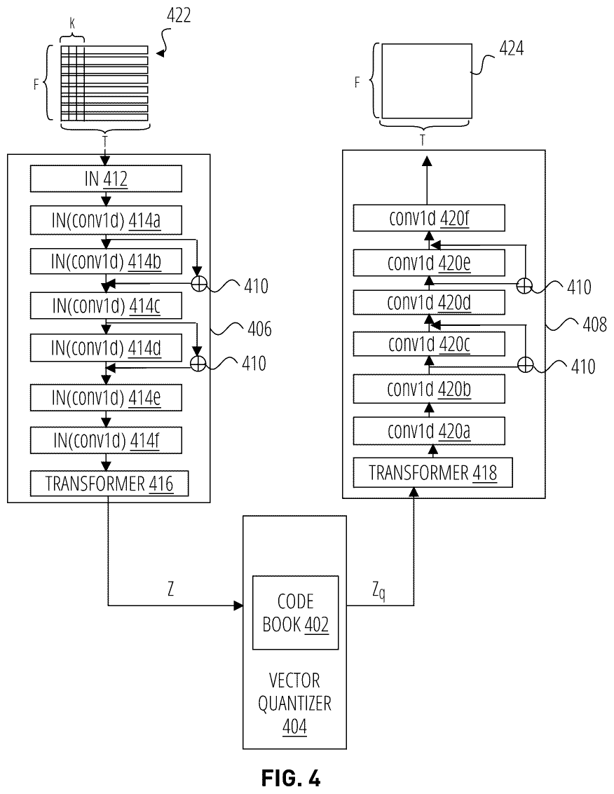

FIG. 4 depicts an embodiment of a deep learning model for speech quality estimation and/or speech quality enhancement. Unlike prior approaches, the learning error may be computed in the model's code book space (i.e., latent space), and not in the domain of the input and output speech signals. This may improve the accuracy of the model at speech quality estimation and/or enhancement over prior approaches.

The model may utilize instance normalization to embed the input speech signals into the model's latent space. Instance normalization is a technique applied to standardize inputs from individual samples into a batch. Instance normalization may be applied in convolutional neural networks (CNNs) and encoder models. For each feature map within an instance, instance normalization may normalize the mean and variance of the activations separately. An ‘instance’ refers to a single sample from the batch. Specifically, instance normalization normalizes the features of each individual sample independently within the batch. This contrasts with batch normalization, which normalizes across the entire batch of samples.

Given an input x^{i,j} at spatial location (i,j) of a feature map:

$${\hat{x}}^{i , j} = \frac{{x}^{i , j} - {u}_{i}}{\sqrt{{σ}_{i}^{2} + ε}}$$

where uᵢ and σᵢ² are the mean and variance of the feature map, and F is a small constant for numerical stability.

After normalization, the normalized value \hat{x}^{i,j} may scaled and shifted using learnable parameters γ (scale) and β (shift):

$${y}^{i , j} = γ {\hat{x}}^{i , j} + β$$

In FIG. 4, the layers labeled “IN(conv1d)” apply instance normalization following a one-dimensional convolutional transformation. This stabilizes and accelerates the training process by reducing internal covariate shift in the network. Instance normalization may facilitate the generation of higher-quality outputs by making the generator independent of the individual instance statistics. It may also assist in preserving fine details by normalizing each instance, enhancing the robustness of the model. Instance normalization focuses on per-instance statistics, making it effective for tasks where preserving content while altering style or appearance is crucial.

By measuring the reconstruction error with a suitable threshold, the model may detect anomalies even though only clean signals are applied for model training. Unlike conventional approaches, a model structured and configured (trained) according to the disclosed mechanisms may leverage an inverse proportion relationship between the reconstruction error and speech quality (i.e., a larger reconstruction error suggests lower speech quality).

Human-centric rating mechanisms may rate speech quality based on an implicit comparison to how clean (undistorted) speech should sound. Training the VQVAE with a large amount of clean speech configures the model with an encoding of what constitutes clean speech (stored in the codebook).

In one embodiment as depicted in FIG. 4, a speech evaluation and/or enhancement model comprises three building blocks: an encoder 406, a vector quantizer 404 comprising a code book 402, and a decoder 408.

The encoder maps an input speech spectrogram 422 X∈R^{F×T} onto a sequence of embeddings Z∈R^{d×T}, where F and T are the frequency and time dimensions of the spectrogram, respectively, and d is the embedding feature dimension. The input spectrogram X may be configured as a T-length 1-dimensional (1-D) signal with F channels, and the encoder may be constructed as a series of 1-D convolution layers, as depicted in FIG. 4.

Let parameters k and c represent the kernel size and number of output channels (number of filters), respectively, for each layer of the encoder 406 and decoder 408. Then in one embodiment:
c=257 for instance normalizer 412
k=7, c=128 for instance normalized convolution layer 414a
k=7, c=128 for instance normalized convolution layer 414b
k=7, c=64 for instance normalized convolution layer 414c
k=7, c=64 for instance normalized convolution layer 414d
k=7, c=d for instance normalized convolution layer 414e
k=7, c=d for instance normalized convolution layer 414f
k=7, c=d for convolution layer 420a
k=7, c=64 for convolution layer 420b
k=7, c=64 for convolution layer 420c
k=7, c=128 for convolution layer 420d
k=7, c=128 for convolution layer 420e
k=7, c=257 for convolution layer 420f

Adders 410 may be utilized between some layers to improve the performance of training and/or inference.

In the depicted embodiment instance normalization (IN) is applied to input X and also after every convolutional layer. This may improve the performance of the quality estimation. Between the IN and convolution layers, a LeakyReLU activation function may be implemented in some embodiments.

In some embodiments, encoder transformer models 416, 418 may be inserted before and after the vector quantizer 404. The standard deviation normalization used in conventional instance normalizer layers may be unsuitable for speech enhancement due to the importance of volume information for signal reconstruction. Therefore, the instance normalization utilized in the disclosed models for speech enhancement may utilize only the mean removal operation for instance normalization.

In one embodiment, the transformers 416, 418 comprise BLSTM networks. A BLSTM transformer combines Bidirectional Long Short-Term Memory (BLSTM) networks with transformer model structures. BLSTM networks are a type of recurrent neural network (RNN) that processes data in both forward and backward directions, enhancing the model's ability to understand context from both past and future states. The transformer model is a type of deep learning architecture designed for handling sequential data, primarily known for its self-attention mechanism, which allows it to weigh the importance of different elements in a sequence.

Incorporating BLSTM into a transformer model leverages the capabilities of both architectures: the temporal representations and sequence dependencies captured by BLSTM, and the efficient, scalable attention mechanisms of transformers.

The vector quantizer 404 replaces each embedding Zₜ∈R^{d×1} with its nearest neighbor in the codebook C∈R^{d×V}, where t is the index along the time dimension and V is the size of the codebook. During training, the codebook may be initialized using a k-means algorithm on a first training batch and updated using an exponential moving average (EMA).

The k-means algorithm provides clustering and partitioning by dividing a set of n inputs into k clusters, where each object is assigned to the cluster with the nearest mean. The algorithm operates to minimize the variance within each cluster.

An exponential moving average (EMA) may be determined by selecting a time interval tᵢ comprising a number of samples N to include in the average. A multiplier value is determined as follows:

$$α = \frac{2}{N + 1}$$

In one embodiment of an EMA algorithm, an initial EMA value of the first N samples is calculated as a Simple Moving Average as follows:

$$E M {A}_{initial} = \frac{{{\sum }_{i = 1}}^{N} {sample}_{i}}{N}$$

Subsequent EMA values are calculated as follows:

$$E M {A}_{current} = ( {sample}_{current} \times α ) + ( E M {A}_{prior} \times ( 1 - α ) )$$

By iteratively applying this formula, the EMA provides more weight to recent samples, enabling it to respond more quickly to changes compared to a simple moving average.

During inference, quantized embeddings Z_{qt}∈R^{d×1} are chosen from V candidates of the code book 402 to substitute for the embeddings generated by the encoder 406. The selected substitution for a particular embedding may be the code book 402 values comprising the lowest L2 distance from the embedding:

$${Z}_{q t} = {arg\_min}_{{C}_{v} ∈ C} {‖ {Z}_{t} - {C}_{v} ‖}_{2} \qquad ( 1 )$$

The embedding and codebook may be normalized to a unit L2 norm before calculating the L2 distance, as follows:

$${Z}_{q t} = {arg\_min}_{{C}_{v} ∈ C} {‖ {norm}_{L 2} ( {Z}_{t} ) - {norm}_{L 2} ( {C}_{v} ) ‖}_{2} \qquad ( 2 )$$

This is equivalent to choosing the quantized embedding based on cosine similarity. Eq. 1 or Eq. 2 may be selected according to the model application. For example, Eq. 1 may be utilized for speech enhancement while Eq. 2 may be utilized to model speech quality.

The decoder 408 generates a reconstructed speech spectrogram 424 (\hat{X}∈R^{F×T}) of the input speech spectrogram 422 using the quantized embeddings.

The training loss function of the model may comprise three loss terms as follows:

$$L = dist ( X , \hat{X} ) + {‖ sg ( {Z}_{t} ) - {Z}_{q t} ‖}_{2} + β {‖ {Z}_{t} - sg ( {Z}_{q t} ) ‖}_{2} \qquad ( 3 )$$

where sg(·) represents a stop-gradient operator. The stop-gradient operator halts the propagation of gradients during the backpropagation process, enabling specific components of the model to be evaluated during the forward pass but preventing gradient updates in those parts during the backward pass. It is useful for fixing certain layers or components of the model, thereby preventing the weights or other parameters of those layers or components from being updated. This can be particularly beneficial for fine-tuning the model or when certain parameters should remain unchanged during training.

The first error term is applied to update the encoder and decoder with the reconstruction loss. The second term is used to update the codebook, where, in practice, the EMA is applied. The third term is a commitment loss used to update the encoder. The commitment weight R may for example be set to 1.0 and 3.0 for quality estimation and speech enhancement, respectively.

The dist(·) operator in the first loss term represents a negative cosine similarity. Conventionally, an L1 or L2 loss would be utilized here. However, for speech quality estimation, a negative cosine similarity enables similar phonemes to be grouped in the same token of the codebook. Using cosine similarity ignores volume differences and focus more on the content of the speech. Applying L2 loss to minimize the reconstruction loss may lead to louder and quieter phonemes that are otherwise similar not being grouped into the same code, which hinders the evaluation of speech quality.

In conventional autoencoder-based speech anomaly detection, the criterion for determining an anomaly is based on the reconstruction errors of the model input and output (in the time and/or frequency domains). The disclosed models operate differently, utilizing the quantization error between Z and Z_{q} to represent a correlation to human hearing perception. Because the disclosed models may be trained using only clean (non-anomalous) speech signals, the resulting code book 402 provides a high-level representation of the phonemes found in speech signals. A similarity metric calculated in the model's latent space therefor aligns with subjective (human) quality scores.

In one embodiment a similarity metric is determined as:

$${VQScore}_{( cos , z )} ( X ) = \frac{1}{T} {\sum }_{t = 1}^{T} cos ( {Z}_{t} , {Z}_{q t} ) \qquad ( 4 )$$

where cos(·) is a cosine similarity distance metric calculated in code space z.

Quality enhancement is enabled once the encoder 406 is trained to map noisy speech to the corresponding tokens of clean speech. Speech enhancement is enabled once the decoder is trained to correct noisy speech.

In one embodiment, self-supervised model training for speech enhancement begins by training a variational autoencoder with clean speech signals, using Eq. (3). After the training converges, the resulting model is deployed as a teacher model T. A student model S is then generated from the weights of the teacher model T. A self-distillation mechanism is then applied to the student model as described below.

First, an adversarial attack is performed on the encoder 406 of the student model. The adversarial attack comprises confusing noise signals to urge the encoder 406 to generate erroneous speech token predictions. Then, to further improve the robustness of the student model, both the encoder 406 and the decoder 408 are fine-tuned using adversarial training, with the codebook of the student model being fixed (held static). The codebook, encoder, and decoder of the teacher model remain fixed during adversarial attack and training of the student model.

Rather than injecting predefined noise signals to the clean input speech that follow a certain probability distribution (e.g., Gaussian noise), adversarial noise is applied, comprising noise likely to confuse the model into making incorrect token predictions. Given a clean speech signal X a quantized token Z_{Tq} may be obtained from the encoder of the teacher model using Eq. (1). The adversarial noise 6 to apply to the encoder (S_{enc}) of the student model may be determined by applying the following optimization problem:

$${max}_{δ} {L}_{ce} ( {S}_{enc} ( X + δ ) , {Z}_{{T}_{q}} \vert C ) \qquad ( 5 )$$

This token selection algorithm is based on the distance between the encoder output and the candidates in the code book C, (i.e., Eq. (1). The algorithm may therefore be formulated as a probability distribution based on the distance and a Softmax operation (e.g., if the distance is smaller, it is more likely to be chosen). The cross-entropy loss L_{ce} in Eq. (5) may therefore be determined from:

$${L}_{ce} = \frac{1}{T} {\sum }_{t = 1}^{T} log ( \frac{exp ( - {‖ {{S}_{enc} ( X + δ )}_{t} - {Z}_{{T}_{q t}} ‖}_{2} )}{{\sum }_{v = 1}^{V} exp ( - {‖ ( {S}_{enc} ( X + δ ) - {C}_{v} ‖}_{2} )} ) \qquad ( 6 )$$

The obtained adversarial noise 6, when added to the clean speech X, will maximize the cross-entropy loss between tokens from the student and teacher model.

To improve the robustness of the encoder of the student model, the adversarial attacked input X+δ may be applied to the student model and the weights of the encoder updated to minimize the cross-entropy loss between its token predictions and the ground truth tokens provided by the teacher model (with clean speech as input) using the following loss function:

$${min}_{{S}_{enc}} {L}_{c e} ( {S}_{enc} ( X + δ ) , {Z}_{{T}_{q}} \vert C ) \qquad ( 7 )$$

Z_{Tq} is applied from the teacher to the student model during adversarial attack with code book 402 and encoder 406 of the student model held fixed. Z_{Tq} is applied from the teacher model to the student model during adversarial training with only the code book 402 of the student held fixed.

Adversarial attack and adversarial training may be applied alternatively. The student model in its final trained configuration may be deployed as a speech enhancement model.

To obtain a more robust decoder 408 of the student model, an L1 loss between the clean speech input and the decoder output (reconstructed speech spectrogram 424), with adversarial attacked tokens used as inputs, may also be applied.

The deep learning models and mechanisms disclosed herein may be implemented as logic, e.g., machine-readable instructions stored in a non-transitory machine memory device or devices, that configures computing devices utilizing one or more graphic processing unit (GPU) and/or general purpose data processor (e.g., a ‘central processing unit or CPU). Exemplary architectures will now be described that may be configured to implement the models and mechanisms disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

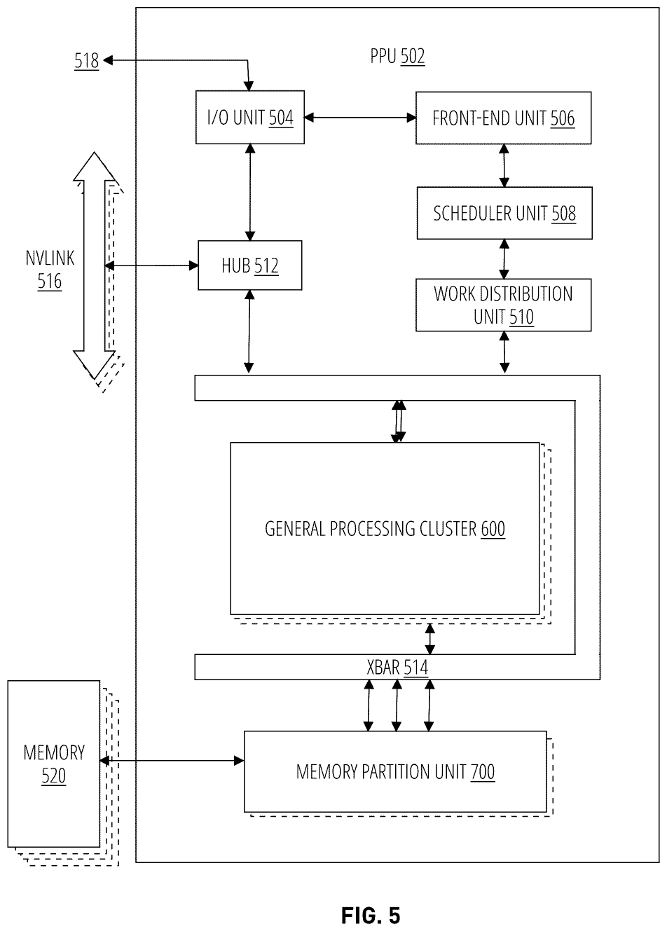

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 600 modules, and one or more memory partition unit 700 modules. The parallel processing unit 502 may be connected to a host processor or other parallel processing unit 502 modules via one or more high-speed NVLink 516 interconnects. The parallel processing unit 502 may be connected to a host processor or other peripheral devices via an interconnect 518. The parallel processing unit 502 may also be connected to a local memory comprising a number of memory 520 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 520 may comprise logic to configure the parallel processing unit 502 to carry out aspects of the techniques disclosed herein.

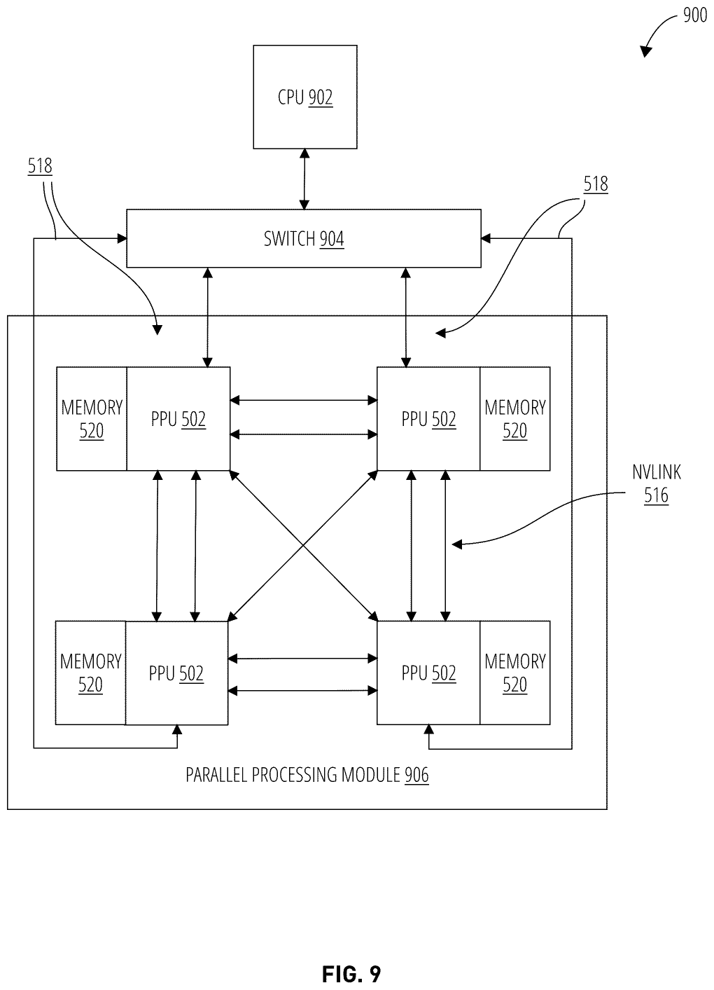

The NVLink 516 interconnect enables systems to scale and include one or more parallel processing unit 502 modules combined with one or more CPUs, supports cache coherence between the parallel processing unit 502 modules and CPUs, and CPU mastering. Data and/or commands may be transmitted by the NVLink 516 through the hub 512 to/from other units of the parallel processing unit 502 such as one or more copy engines, a video encoder, a video decoder, a power management unit, etc. (not explicitly shown). The NVLink 516 is described in more detail in conjunction with FIG. 9.

The I/O unit 504 is configured to transmit and receive communications (e.g., commands, data, etc.) from a host processor (not shown) over the interconnect 518. The I/O unit 504 may communicate with the host processor directly via the interconnect 518 or through one or more intermediate devices such as a memory bridge. In an embodiment, the I/O unit 504 may communicate with one or more other processors, such as one or more parallel processing unit 502 modules via the interconnect 518. In an embodiment, the I/O unit 504 implements a Peripheral Component Interconnect Express (PCIe) interface for communications over a PCIe bus and the interconnect 518 is a PCIe bus. In alternative embodiments, the I/O unit 504 may implement other types of well-known interfaces for communicating with external devices.

The I/O unit 504 decodes packets received via the interconnect 518. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 518 via memory requests transmitted over the interconnect 518. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 600 modules to process tasks defined by the one or more streams. The scheduler unit 508 is configured to track state information related to the various tasks managed by the scheduler unit 508. The state may indicate which general processing cluster 600 a task is assigned to, whether the task is active or inactive, a priority level associated with the task, and so forth. The scheduler unit 508 manages the execution of a plurality of tasks on the one or more general processing cluster 600 modules.

The scheduler unit 508 is coupled to a work distribution unit 510 that is configured to dispatch tasks for execution on the general processing cluster 600 modules. The work distribution unit 510 may track a number of scheduled tasks received from the scheduler unit 508. In an embodiment, the work distribution unit 510 manages a pending task pool and an active task pool for each of the general processing cluster 600 modules. The pending task pool may comprise a number of slots (e.g., 32 slots) that contain tasks assigned to be processed by a particular general processing cluster 600. The active task pool may comprise a number of slots (e.g., 4 slots) for tasks that are actively being processed by the general processing cluster 600 modules. As a general processing cluster 600 finishes the execution of a task, that task is evicted from the active task pool for the general processing cluster 600 and one of the other tasks from the pending task pool is selected and scheduled for execution on the general processing cluster 600. If an active task has been idle on the general processing cluster 600, such as while waiting for a data dependency to be resolved, then the active task may be evicted from the general processing cluster 600 and returned to the pending task pool while another task in the pending task pool is selected and scheduled for execution on the general processing cluster 600.

The work distribution unit 510 communicates with the one or more general processing cluster 600 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 600. Although not shown explicitly, one or more other units of the parallel processing unit 502 may also be connected to the crossbar 514 via the hub 512.

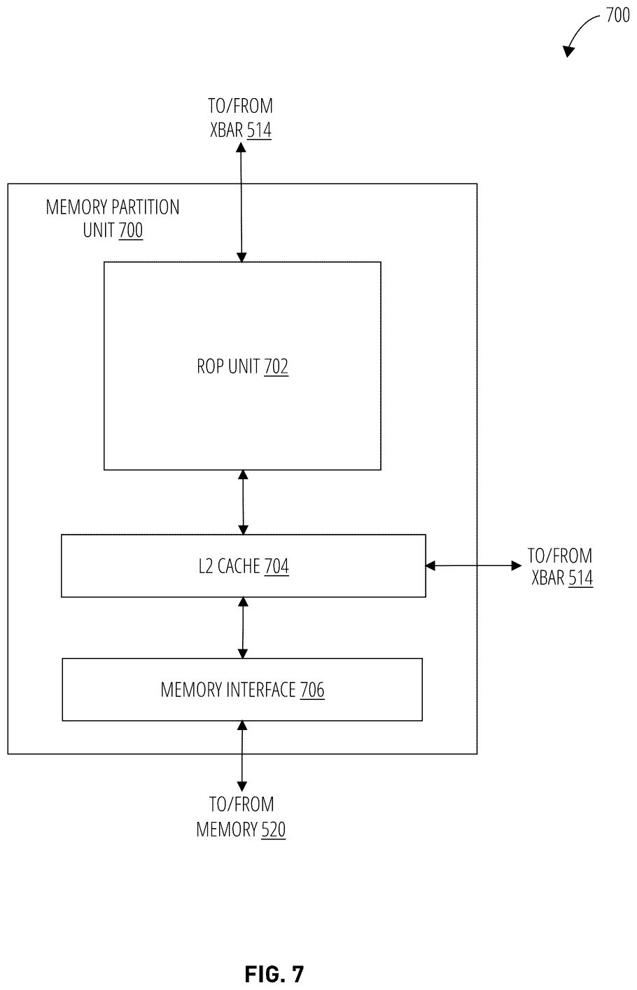

The tasks are managed by the scheduler unit 508 and dispatched to a general processing cluster 600 by the work distribution unit 510. The general processing cluster 600 is configured to process the task and generate results. The results may be consumed by other tasks within the general processing cluster 600, routed to a different general processing cluster 600 via the crossbar 514, or stored in the memory 520. The results can be written to the memory 520 via the memory partition unit 700 modules, which implement a memory interface for reading and writing data to/from the memory 520. The results can be transmitted to another parallel processing unit 502 or CPU via the NVLink 516. In an embodiment, the parallel processing unit 502 includes a number U of memory partition unit 700 modules that is equal to the number of separate and distinct memory 520 devices coupled to the parallel processing unit 502. A memory partition unit 700 will be described in more detail below in conjunction with FIG. 7.

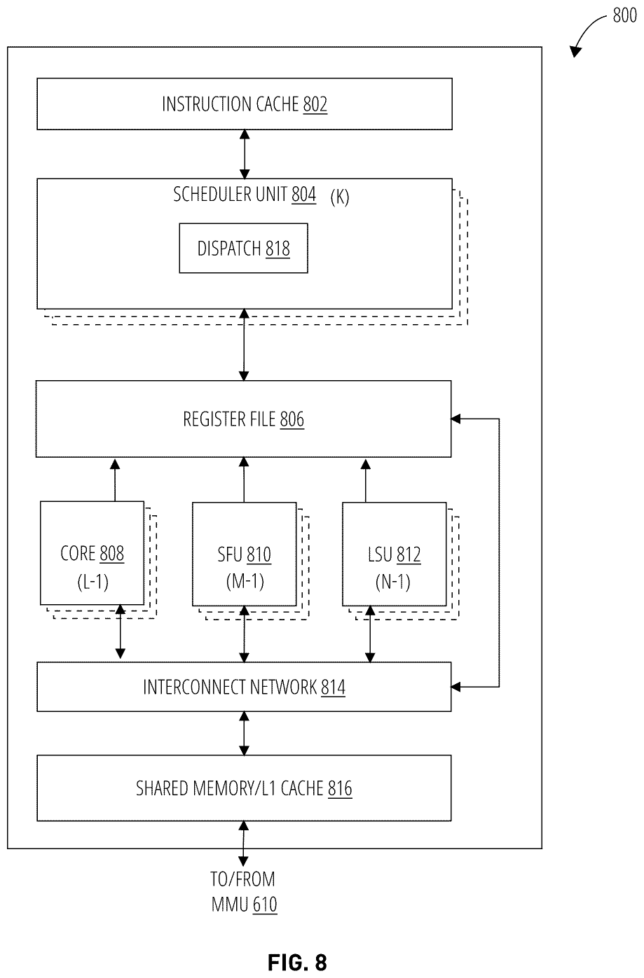

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QoS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

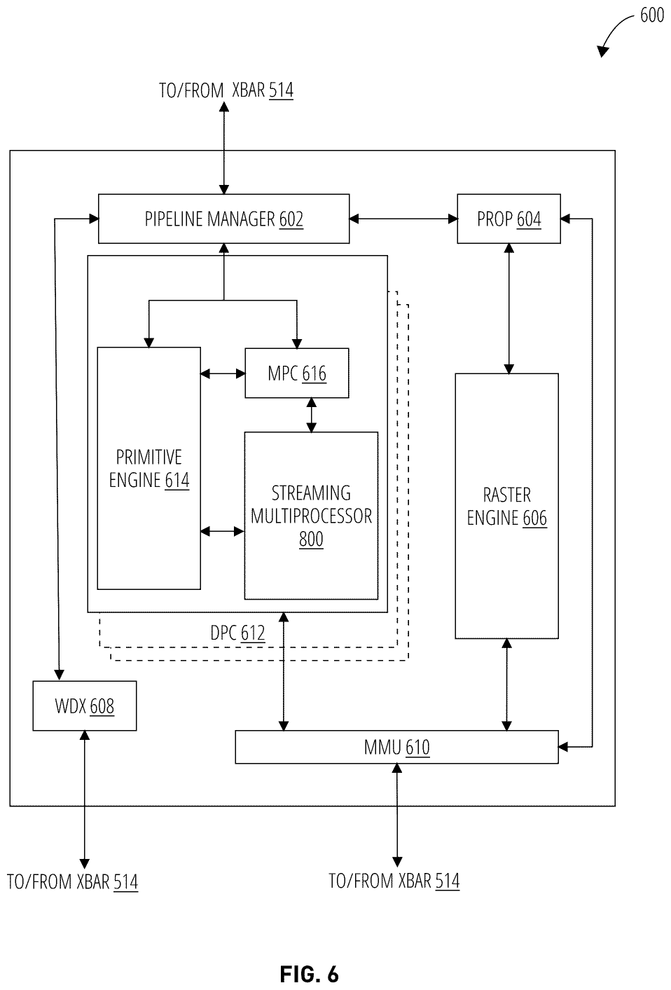

FIG. 6 depicts a general processing cluster 600 of the parallel processing unit 502 of FIG. 5, in accordance with an embodiment. As shown in FIG. 6, each general processing cluster 600 includes a number of hardware units for processing tasks. In an embodiment, each general processing cluster 600 includes a pipeline manager 602, a pre-raster operations unit 604, a raster engine 606, a work distribution crossbar 608, a memory management unit 610, and one or more data processing cluster 612. It will be appreciated that the general processing cluster 600 of FIG. 6 may include other hardware units in lieu of or in addition to the units shown in FIG. 6.

In an embodiment, the operation of the general processing cluster 600 is controlled by the pipeline manager 602. The pipeline manager 602 manages the configuration of the one or more data processing cluster 612 modules for processing tasks allocated to the general processing cluster 600. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 800. The pipeline manager 602 may also be configured to route packets received from the work distribution unit 510 to the appropriate logical units within the general processing cluster 600. For example, some packets may be routed to fixed function hardware units in the pre-raster operations unit 604 and/or raster engine 606 while other packets may be routed to the data processing cluster 612 modules for processing by the primitive engine 614 or the streaming multiprocessor 800. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 600 includes an M-pipe controller 616, a primitive engine 614, and one or more streaming multiprocessor 800 modules. The M-pipe controller 616 controls the operation of the data processing cluster 612, routing packets received from the pipeline manager 602 to the appropriate units in the data processing cluster 612. For example, packets associated with a vertex may be routed to the primitive engine 614, which is configured to fetch vertex attributes associated with the vertex from the memory 520. In contrast, packets associated with a shader program may be transmitted to the streaming multiprocessor 800.

The streaming multiprocessor 800 comprises a programmable streaming processor that is configured to process tasks represented by a number of threads. Each streaming multiprocessor 800 is multi-threaded and configured to execute a plurality of threads (e.g., 32 threads) from a particular group of threads concurrently. In an embodiment, the streaming multiprocessor 800 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 800 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 800 will be described in more detail below in conjunction with FIG. 8.

The memory management unit 610 provides an interface between the general processing cluster 600 and the memory partition unit 700. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 520.

FIG. 7 depicts a memory partition unit 700 of the parallel processing unit 502 of FIG. 5, in accordance with an embodiment. As shown in FIG. 7, the memory partition unit 700 includes a raster operations unit 702, a level two cache 704, and a memory interface 706. The memory interface 706 is coupled to the memory 520. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 700 modules, where each pair of memory partition unit 700 modules is connected to a corresponding memory 520 device. For example, parallel processing unit 502 may be connected to up to Y memory 520 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 520 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 700 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 516 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 700 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 520 or other system memory may be fetched by the memory partition unit 700 and stored in the level two cache 704, which is located on-chip and is shared between the various general processing cluster 600 modules. As shown, each memory partition unit 700 includes a portion of the level two cache 704 associated with a corresponding memory 520 device. Lower level caches may then be implemented in various units within the general processing cluster 600 modules. For example, each of the streaming multiprocessor 800 modules may implement an L1 cache. The L1 cache is private memory that is dedicated to a particular streaming multiprocessor 800. Data from the level two cache 704 may be fetched and stored in each of the L1 caches for processing in the functional units of the streaming multiprocessor 800 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 700 modules may be different than the number of general processing cluster 600 modules and, therefore, each raster operations unit 702 may be coupled to each of the general processing cluster 600 modules. The raster operations unit 702 tracks packets received from the different general processing cluster 600 modules and determines which general processing cluster 600 that a result generated by the raster operations unit 702 is routed to through the crossbar 514. Although the raster operations unit 702 is included within the memory partition unit 700 in FIG. 7, in other embodiment, the raster operations unit 702 may be outside of the memory partition unit 700. For example, the raster operations unit 702 may reside in the general processing cluster 600 or another unit.

FIG. 8 illustrates the streaming multiprocessor 800 of FIG. 6, in accordance with an embodiment. As shown in FIG. 8, the streaming multiprocessor 800 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 600 modules of the parallel processing unit 502. The tasks are allocated to a particular data processing cluster 612 within a general processing cluster 600 and, if the task is associated with a shader program, the task may be allocated to a streaming multiprocessor 800. The scheduler unit 508 receives the tasks from the work distribution unit 510 and manages instruction scheduling for one or more thread blocks assigned to the streaming multiprocessor 800. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 800 includes a register file 806 that provides a set of registers for the functional units of the streaming multiprocessor 800. In an embodiment, the register file 806 is divided between each of the functional units such that each functional unit is allocated a dedicated portion of the register file 806. In another embodiment, the register file 806 is divided between the different warps being executed by the streaming multiprocessor 800. The register file 806 provides temporary storage for operands connected to the data paths of the functional units.

Each streaming multiprocessor 800 comprises L processing core 808 modules. In an embodiment, the streaming multiprocessor 800 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 800 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 520 and sample the texture maps to produce sampled texture values for use in shader programs executed by the streaming multiprocessor 800. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 800 includes two texture units.

Each streaming multiprocessor 800 also comprises N load/store unit 812 modules that implement load and store operations between the shared memory/L1 cache 816 and the register file 806. Each streaming multiprocessor 800 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 800 and the primitive engine 614 and between threads in the streaming multiprocessor 800. In an embodiment, the shared memory/L1 cache 816 comprises 128 KB of storage capacity and is in the path from the streaming multiprocessor 800 to the memory partition unit 700. The shared memory/L1 cache 816 can be used to cache reads and writes. One or more of the shared memory/L1 cache 816, level two cache 704, and memory 520 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 800 to execute the program and perform calculations, shared memory/L1 cache 816 to communicate between threads, and the load/store unit 812 to read and write global memory through the shared memory/L1 cache 816 and the memory partition unit 700. When configured for general purpose parallel computation, the streaming multiprocessor 800 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 520, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system 900 implemented using the parallel processing unit 502 of FIG. 5, in accordance with an embodiment. The processing system 900 includes a central processing unit 902, switch 904, and multiple parallel processing unit 502 modules each and respective memory 520 modules. The NVLink 516 provides high-speed communication links between each of the parallel processing unit 502 modules. Although a particular number of NVLink 516 and interconnect 518 connections are illustrated in FIG. 9, the number of connections to each parallel processing unit 502 and the central processing unit 902 may vary. The switch 904 interfaces between the interconnect 518 and the central processing unit 902. The parallel processing unit 502 modules, memory 520 modules, and NVLink 516 connections may be situated on a single semiconductor platform to form a parallel processing module 906. In an embodiment, the switch 904 supports two or more protocols to interface between various different connections and/or links.

In another embodiment (not shown), the NVLink 516 provides one or more high-speed communication links between each of the parallel processing unit modules (parallel processing unit 502, parallel processing unit 502, parallel processing unit 502, and parallel processing unit 502) and the central processing unit 902 and the switch 904 interfaces between the interconnect 518 and each of the parallel processing unit modules. The parallel processing unit modules, memory 520 modules, and interconnect 518 may be situated on a single semiconductor platform to form a parallel processing module 906. In yet another embodiment (not shown), the interconnect 518 provides one or more communication links between each of the parallel processing unit modules and the central processing unit 902 and the switch 904 interfaces between each of the parallel processing unit modules using the NVLink 516 to provide one or more high-speed communication links between the parallel processing unit modules. In another embodiment (not shown), the NVLink 516 provides one or more high-speed communication links between the parallel processing unit modules and the central processing unit 902 through the switch 904. In yet another embodiment (not shown), the interconnect 518 provides one or more communication links between each of the parallel processing unit modules directly. One or more of the NVLink 516 high-speed communication links may be implemented as a physical NVLink interconnect or either an on-chip or on-die interconnect using the same protocol as the NVLink 516.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 520 modules may be packaged devices. In an embodiment, the central processing unit 902, switch 904, and the parallel processing module 906 are situated on a single semiconductor platform.

In an embodiment, the signaling rate of each NVLink 516 is 20 to 25 Gigabits/second and each parallel processing unit module includes six NVLink 516 interfaces (as shown in FIG. 9, five NVLink 516 interfaces are included for each parallel processing unit module). Each NVLink 516 provides a data transfer rate of 25 Gigabytes/second in each direction, with six links providing 300 Gigabytes/second. The NVLink 516 can be used exclusively for PPU-to-PPU communication as shown in FIG. 9, or some combination of PPU-to-PPU and PPU-to-CPU, when the central processing unit 902 also includes one or more NVLink 516 interfaces.

In an embodiment, the NVLink 516 allows direct load/store/atomic access from the central processing unit 902 to each parallel processing unit module's memory 520. In an embodiment, the NVLink 516 supports coherency operations, allowing data read from the memory 520 modules to be stored in the cache hierarchy of the central processing unit 902, reducing cache access latency for the central processing unit 902. In an embodiment, the NVLink 516 includes support for Address Translation Services (ATS), enabling the parallel processing unit module to directly access page tables within the central processing unit 902. One or more of the NVLink 516 may also be configured to operate in a low-power mode.

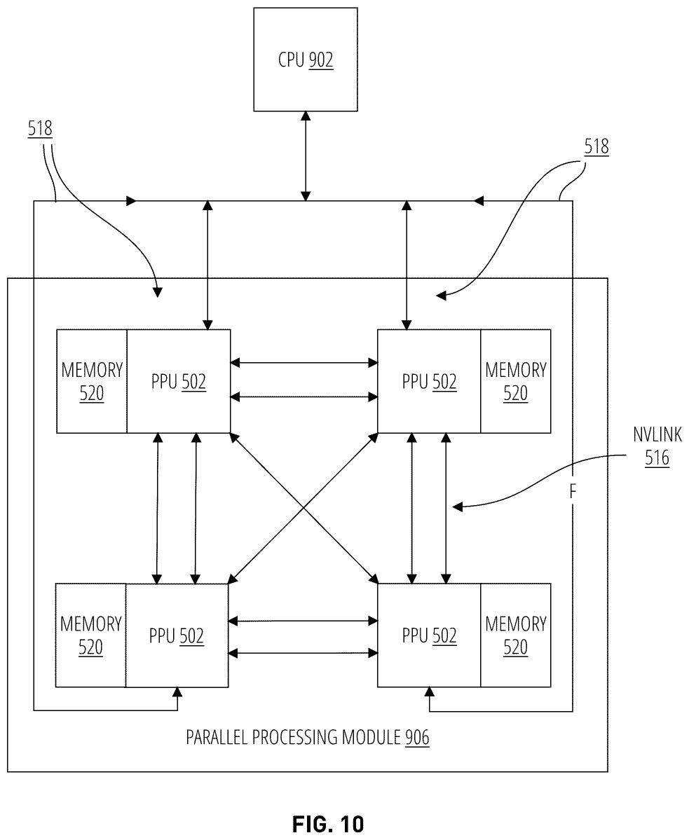

FIG. 10 is a conceptual diagram of a processing system in accordance with another embodiment. The processing system comprises similar features to the processing system 900 depicted in FIG. 9, except that the intervening switch 904 between the parallel processing units 502 and the one or more central processing units 902 is obviated in favor of a more direct link. Obviating the switch 904 may enable higher bandwidth between the parallel processing units 502 and the central processing unit(s) 902 and may also reduce circuit area and/or power consumption.

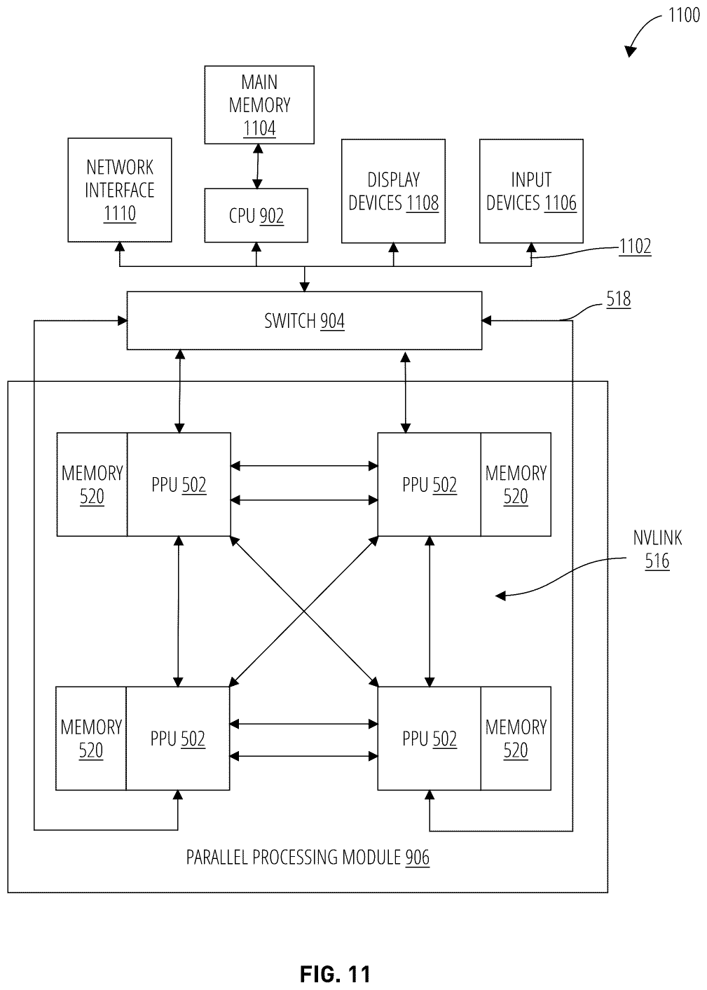

FIG. 11 depicts an exemplary processing system 1100 in which the various architecture and/or functionality of the various previous embodiments may be implemented. As shown, an exemplary processing system 1100 is provided including at least one central processing unit 902 that is connected to a communications bus 1102. The communication communications bus 1102 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1100 also includes a main memory 1104. Control logic (software) and data are stored in the main memory 1104 which may take the form of random access memory (RAM).

The exemplary processing system 1100 also includes input devices 1106, the parallel processing module 906, and display devices 1108, e.g. a conventional CRT (cathode ray tube), LCD (liquid crystal display), LED (light emitting diode), plasma display or the like. User input may be received from the input devices 1106, e.g., keyboard, mouse, touchpad, microphone, and the like. Each of the foregoing modules and/or devices may even be situated on a single semiconductor platform to form the exemplary processing system 1100. Alternately, the various modules may also be situated separately or in various combinations of semiconductor platforms per the desires of the user.

Further, the exemplary processing system 1100 may be coupled to a network (e.g., a telecommunications network, local area network (LAN), wireless network, wide area network (WAN) such as the Internet, peer-to-peer network, cable network, or the like) through a network interface 1110 for communication purposes.

The exemplary processing system 1100 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1104 and/or the secondary storage. Such computer programs, when executed, enable the exemplary processing system 1100 to perform various functions. The main memory 1104, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1100 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A training system to configure a deep learning model for speech quality estimation or speech quality enhancement, the training system comprising:
an encoder configured to transform input speech signals into estimated speech tokens;
a code book configured to quantize the estimated speech tokens;
a decoder configured to transform the quantized speech tokens into output speech signals; and
logic configured to apply a difference between the estimated speech tokens and the quantized speech tokens to detect speech anomalies in the input speech signals.

2. The training system of claim 1, wherein the logic configured to apply a difference between the estimated speech tokens and the quantized speech tokens to detect speech anomalies in the input speech signals comprises logic to determine a cosine similarity distance between the estimated speech tokens and the quantized speech tokens.

3. The training system of claim 1, wherein the deep learning model comprises:
an encoder;
a decoder; and
a vector quantizer interposed between the encoder and the decoder;

4. The training system of claim 3, wherein the vector quantizer comprises a code book configured with the quantized speech tokens.

5. The training system of claim 4, wherein the deep learning model further comprises loss determination logic.

6. The training system of claim 5, wherein the loss determination logic comprises:
logic to determine a reconstruction loss to apply to update weights of the encoder and the decoder;
logic to determine a loss to apply to update the quantized speech tokens of the code book; and
logic to determine a commitment loss to apply to update the weights of the encoder.

7. The training system of claim 6, wherein the logic to determine a loss to apply to update the quantized speech tokens and the logic to determine a commitment loss each comprise a stop gradient operator.

8. The training system of claim 4, wherein the vector quantizer is configured to replace the estimated speech tokens with their nearest neighbors in the code book.

9. The training system of claim 8, wherein the vector quantizer is configured to replace the estimated speech tokens with code book entries that best satisfy a negative cosine similarity between the input speech signals and the output speech signals.

10. The training system of claim 4, further comprising logic to configure the code book by applying a k-means algorithm on a first training batch of speech signals input to the deep learning model and updating the code book by applying an exponential moving average for subsequent training batches.

11. The training system of claim 3, wherein the encoder comprises a plurality of instance normalized convolution layers arranged in series.

12. The training system of claim 3, wherein the decoder comprises a plurality of convolution layers arranged in series.

13. The training system of claim 3, further comprising a plurality of transformer models interposed between the encoder and the decoder.

14. The training system of claim 1, further comprising:
logic to generate a student model from the deep learning model; and
logic to apply self-distillation to the student model.

15. The training system of claim 14, wherein the logic to apply self-distillation to the student model comprises:
logic to apply an adversarial attack on the student model; and
logic to apply adversarial training to the student model.

16. The training system of claim 15, wherein the adversarial attack is applied to train a decoder of the student model.

17. The training system of claim 15, wherein the adversarial training is applied to train an encoder and a decoder of the student model.

18. A computer system comprising:
at least one processor;
a memory comprising instructions that when applied to the at least one processor, configure the computer system to:
transform input speech signals into estimated speech tokens;
quantize the estimated speech tokens;
transform the quantized speech tokens into output speech signals; and
apply a difference between the estimated speech tokens and the quantized speech tokens to detect speech anomalies in the input speech signals.

19. A process for training an artificial intelligence model, the process comprising:
transforming input speech signals into estimated speech tokens with an encoder;
operating a vector quantizer comprising a code book of quantized speech tokens on the estimated speech tokens;
transforming the quantized speech tokens into output speech signals with a decoder;
apply a cosine similarity distance between the estimated speech tokens and the quantized speech tokens to detect speech anomalies in the input speech signals.

20. The process of claim 19, wherein the vector quantizer replaces the estimated speech tokens with their nearest neighbors in the code book.
